(19) United States
(12) Patent Application Publication
(10) Pub. No.: US 2014/0074316 A1
(43) Pub. Date: Mar. 13, 2014

(54) ELECTRONIC CONTROL UNIT OF VEHICLE

(71) Applicant: KEIHIN CORPORATION, Tokyo (JP)

(72) Inventors: Satoru Kanno, Shioya-gun (JP); Hideki Watanabe, Shioya-gun (JP); Takako Hanatsuka, Shioya-gun (JP)

(73) Assignee: KEIHIN CORPORATION, Tokyo (JP)

(21) Appl. No.: 14/019,701

(22) Filed: Sep. 6, 2013

(30) Foreign Application Priority Data
Sep. 12, 2012 (JP) 2012-200316

(51) Int. Cl. B60W 50/00

(52) U.S. Cl. CPC B60W 50/00
USPC 701/1

(57) ABSTRACT

In an electronic control unit that controls a control target device based on control data stored in a storage unit, when control data is written in the storage unit of the electronic control unit from a data processing device at a manufacturer side, a hash-code generation unit creates a hash code corresponding to the control data. The hash code is stored as second storage data.

The present application claims priority under 35 U.S.C. §119 to Japanese Patent Application No. 2012-200316 with a filing date of September 12, 2012. The contents of this application are incorporated herein by reference in their entirety.

### TECHNICAL FIELD

The present disclosure relates to an electronic control unit, and more particularly relates to an electronic control unit of a vehicle that records an update history of control data for vehicle-mounted devices.

### BACKGROUND

On vehicles such as automobiles, an electronic control unit (ECU) that controls a vehicle-mounted device such as an engine is mounted. In the electronic control unit, control data to be used for control of the engine and the like is stored beforehand in a so-called “flash ROM (Read Only Memory)”. The control data includes a control program and a control value, and the control program is executed by a CPU (Central Processing Unit) in the electronic control unit and the control value is used for the computation by the CPU, thereby controlling the engine and the like. Further, when there is a specification change or the like in the control program, the storage contents in the flash ROM may be rewritten by a manufacturer or a dealer of the vehicle.

In this manner, the storage contents in the flash ROM of the electronic control unit may be rewritten by an access from outside. The electronic control unit may have such a configuration that when the control data is rewritten, the rewrite history is stored.

For example, in a four-wheels vehicle, a separate electronic control unit, for instance, a control unit of a navigation device is mounted in addition to the electronic control unit that controls the engine and the like, and a configuration in which when the control data of the electronic control unit is rewritten, change history information thereof is written in the separate electronic control unit has been adopted. Further, the change history information includes received date and time of the control data for update, the electronic control unit to be updated, version information of the control data for update, and update completion date and time (see Japanese Patent Application Laid-open Publication No. 2011-894).

In this way, by recording the update history information in the separate electronic control unit, for example, the dealer of the vehicle can confirm whether the control data has been rewritten by a user or the like of the vehicle. Further, the manufacturer of the vehicle can confirm the control data, which has been rewritten and used in a vehicle test or the like, or confirm whether there is any incomplete update of the control data to be updated.

### SUMMARY

However, according to the studies by the present inventors, when a vehicle on which the electronic control unit is mounted, is a small vehicle such as a motorcycle, it is difficult to mount the separate electronic control unit in view of space savings and cost reductions. That is, in such a case, it has been difficult to manage the data update history.

To solve the above problems, it is preferable to record an update history of control data reliably, while achieving space savings.

According to one aspect, a preferable electronic control unit of a vehicle comprises a storage unit that stores therein control data of a control target device, which is mounted on a vehicle, where the electronic control unit controlling the control target device based on the control data stored in the storage unit; a code generation unit that generates a unique code corresponding to control data after a change, when the control data stored in the storage unit is changed; and a code recording unit that records the code.

Furthermore, it is preferable that the code recording unit is configured to add a new code to the code already recorded and store therein the new code, when the code is newly generated.

Further, it is preferable that the code recording unit is configured to arrange and store therein the codes in order of the control data being updated.

According to one aspect, by creating a unique code that is in one-to-one correspondence to corresponding control data, it is possible to confirm an update history of the data without creating the update history in another electronic control unit.

### BRIEF DESCRIPTION OF THE DRAWINGS

FIG. 1 is a block diagram of a schematic configuration of a data update system including an electronic control unit according to an embodiment of the present invention; and

FIG. 2 is an explanatory diagram of a case where there is an access from a user in the data update system including the electronic control unit according to the present embodiment.

### DETAILED DESCRIPTION OF THE PREFERRED EMBODIMENT

A data update system according to a preferred embodiment is explained below in detail with reference to the accompanying drawings.

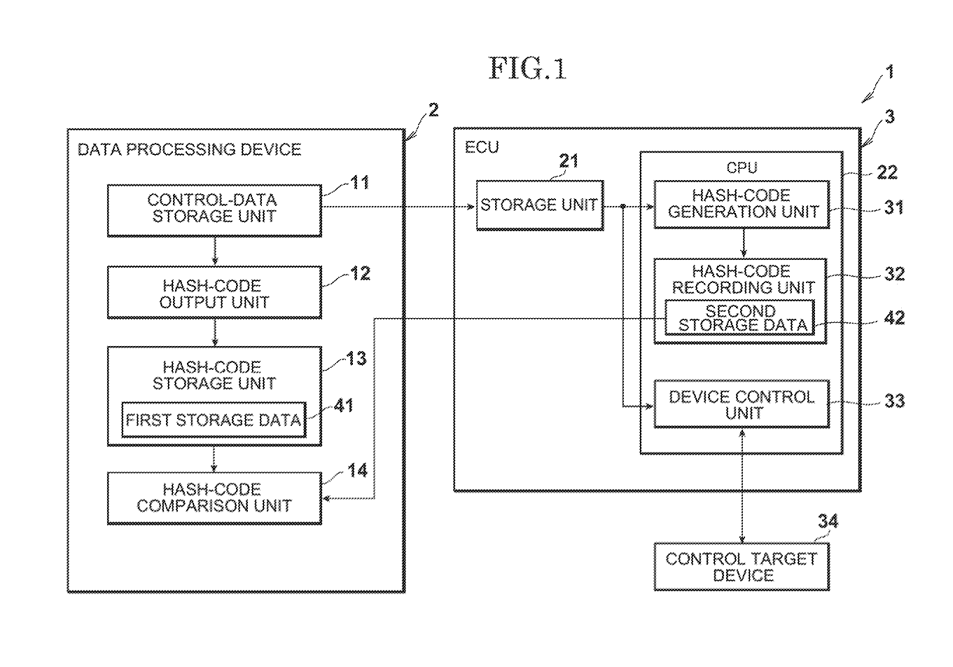

FIG. 1 shows a schematic configuration of a data update system including an electronic control unit of a vehicle.

As shown in FIG. 1, a data update system 1 includes a data processing device 2 to be used by a manufacturer of a vehicle, and an electronic control unit 3 mounted on the vehicle. The data processing device 2 can be provided at a car dealer or the like.

The data processing device 2 can be functionally divided into a control-data storage unit 11 that records control data including a control program and a control value, a hash-code output unit 12 that generates a hash code including unique data defining the control data, a hash-code storage unit 13 that stores therein the hash code, and a hash-code comparison unit 14 that compares a plurality of hash codes. The data processing device 2 may be a computer which includes a processor and a memory device which may cooperatively provide the above functions.

A writable/readable memory is used for the control-data storage unit 11 and the hash-code storage unit 13. The hash-code output unit 12 uses a so-called “hash algorithm”, for example, such a hash algorithm that creates a hash code including integer values and alphabets from a binary code, and the hash code is a unique code that is in one-to-one correspondence to the corresponding control data. The hash-code comparison unit 14 compares first storage data 41 including a hash code stored at the manufacturer side with data of a hash code stored in the onboard electronic control unit of the vehicle, to judge whether the both hash codes match each other.

The electronic control unit 3 of the vehicle includes a storage unit 21 and a CPU 22. A flash ROM is used for the storage unit 21 to store therein control data required for controlling the vehicle such as a control program and a control value. The CPU 22 can be functionally divided into a hash-code generation unit 31 that generates a hash code, a hash-code recording unit 32 that records the hash code as second storage data 42, and a device control unit 33. The device control unit 33 generates a signal or the like that controls a control target device 34 such as an electric component and an engine by using the control data stored in the storage unit 21.

A process at the time of updating the data is explained next by using a case where the control program stored in the storage unit 21 of the electronic control unit 3 is updated as an example. The same process is performed with respect to the control value.

First, the data processing device 2 in the manufacturer and the electronic control unit 3 are connected so that data communication becomes possible. A binary code of the control program for update is then transmitted from the control-data storage unit 11 of the data processing device 2 to the storage unit 21 of the electronic control unit 3.

At this time, the control-data storage unit 11 transfers the same binary code as that of the control program transmitted to the electronic control unit 3 to the hash-code output unit 12 of the data processing device 2. The hash-code output unit 12 generates a hash code from the binary code of the control program by using the hash algorithm prepared beforehand. A data amount of the hash code is much smaller than that of the control program itself, and the hash code is uniquely generated with respect to each control program. The hash code generated in this manner is stored in the hash-code storage unit 13 as the first storage data 41. When there is a hash code already stored therein, the hash-code storage unit 13 adds the new hash code after the existing hash code without replacing the existing hash code by the new hash code, to create and store the first storage data 41.

For example, when data writing has been performed twice with respect to the electronic control unit 3 before the current data update, the hash-code storage unit 13 has already stored and includes two hash codes in the first storage data 41 before the current update in order of write. The two existing hash codes are assumed here as “5ec8eee62e66457b” and “41f2d2da5d83ecf6”, for example. When the hash-code output unit 12 generates a new hash code “7aa0371ff93d0144” in association with data update this time, this new hash code is added after the two existing hash codes, and these three hash codes are stored as the first storage data 41.

That is, the contents of the first storage data 41 are arranged in the following order and stored by the update process this time.

“5ec8eee62e66457b”

“41f2d2da5d83ecf6”

“7aa0371ff93d0144”

Accordingly, when the contents of the first storage data 41 are checked, it is understood that data writing with respect to the electronic control unit 3 has been performed three times, and the data corresponding to the hash code “5ec8eee62e66457b” has been written in the electronic control unit 3 in the first process. Similarly, it is understood that the pieces of data corresponding to “41f2d2da5d83ecf6” and “7aa0371ff93d0144” have been written in the electronic control unit 3 in the second process and the third process.

Meanwhile, the electronic control unit 3 of a vehicle rewrites the control program stored in the storage unit 21 to the control program newly transmitted from the data processing device 2. Thereafter, the device control unit 33 controls the control target device 34 by using the updated new control program. The storage unit 21 transmits a binary code of the new control program to the hash-code generation unit 31 of the CPU 22. The hash-code generation unit 31 generates a hash code from the binary code of the new control program by using the hash algorithm same as the hash algorithm used by the hash-code output unit 12 of the data processing device 2. The generated hash code is stored in the hash-code recording unit 32 as the second storage data 42. When there is a hash code already stored, the hash-code recording unit 32 adds the new hash code after the existing hash code without replacing the existing hash code by the new hash code, to create and store the second storage data 42.

The hash-code output unit 12 in the manufacturer and the hash-code generation unit 31 on a vehicle use the same hash algorithm as described above. Accordingly, the first storage data 41 stored in the hash-code storage unit 13 in the manufacturer and the second storage data 42 stored in the hash-code recording unit 32 on a vehicle have the same contents if there is no falsification or the like. Because newer hash codes are sequentially added and stored, the number of hash codes to be stored and an arrangement order are the same between the first storage data 41 and the second storage data 42. Accordingly, if the electronic control unit 3 is appropriately used, the first storage data 41 and the second storage data 42 are the same. That is, when the hash-code comparison unit 14 compares the two pieces of storage data 41 and 42 with each other, the both pieces of data match each other.

On the other hand, there is explained a case where rewriting, which is not intended by a manufacturer or a dealer, is performed to data of the electronic control unit 3.

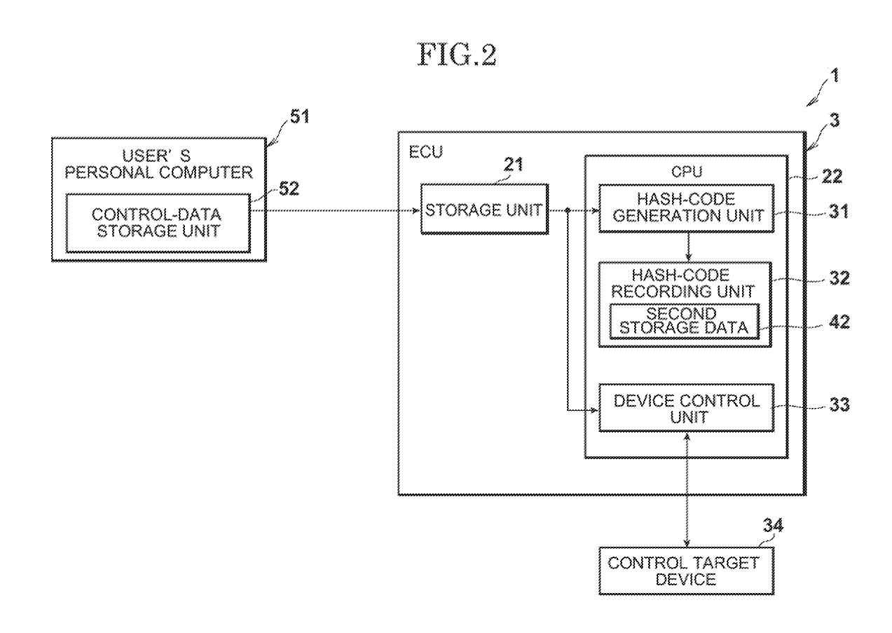

FIG. 2 is an explanatory diagram of a case where there is an access from a user in the data update system including the electronic control unit according to the present embodiment.

For example, as shown in FIG. 2, when a user of a vehicle connects a personal computer 51 to the electronic control unit 3 on the vehicle to write individually created data required for controlling the vehicle, for example, a control program into the storage unit 21 of the electronic control unit 3 from a control-data storage unit 52, the control program in the storage unit 21 of the electronic control unit 3 is rewritten by the control program input from the user.

At this time, the hash-code generation unit 31 of the electronic control unit 3 generates a hash code with respect to the control program written by the user, such as “92c747f65707143b”. Because the control program written by the user is different from the qualified control program, the values of the hash codes are different from each other. The hash-code recording unit 32 creates and stores therein the second storage data 42 added with the hash code “92c747f65707143b” corresponding to the control program written without proper authorization.

Thereafter, as shown in FIG. 1, when the data processing device 2 of the manufacturer is connected to the electronic control unit 3, and the hash-code comparison unit 14 checks whether the first storage data 41 stored in the hash-code storage unit 13 matches the second storage data 42 stored in the hash-code recording unit 32 of the electronic control unit 3 on the vehicle. When the control program is rewritten by the user, the number of hash codes included in the second storage data 42 in the hash-code recording unit 32 increases by the number of rewrite.

For example, a case where data is rewritten by the user between the second and third rewrites is specifically explained. At this time, the first storage data 41 in the data processing device 2 at the manufacturer side is arranged, for example, in the following order and stored.

“5ec8eee62e66457b”

“41f2d2da5d83ecf6”

“7aa0371ff93d0144”

On the other hand, the second storage data 42 in the electronic control unit 3 is arranged, for example, in the following order and stored.

“5ec8eee62e66457b”

“41f2d2da5d83ecf6”

“92c747f65707143b”

“7aa0371ff93d0144”

The first storage data 41 stored at the manufacturer side has three hash codes. On the other hand, the second storage data 42 in the electronic control unit 3 has four hash codes. The second storage data 42 includes one extra hash code having different contents. Therefore, the hash-code comparison unit 14 judges that the pieces of storage data do not match each other, that is, rewriting that is not intended by the manufacturer has been performed. It is understood from the arrangement of the hash codes that the data is rewritten by the user in a period from the second rewrite of data to the third write of data.

As described above, in the present embodiment, when the data is written from outside, unique data defining the written data, for example, a hash code is generated and stored. Because the data amount of the hash code is sufficiently smaller than the original control data, even in a small memory mounted on the electronic control unit 3, the update history can be stored. Because the pieces of storage data 41 and 42 are not overwritten every time data is written, but a new hash code is added to the existing data, the occurrence of data update, which is not intended by a manufacturer or a dealer, can be easily confirmed by checking the contents of the pieces of storage data 41 and 42. Because a separate control unit that stores therein the update history does not need to be provided, the device configuration can be simplified and downsized, thereby enabling to realize cost reductions.

Further, in the present embodiment, because the existing hash code is not deleted but a new hash code is added in the storage data 41 and 42, even if the control data rewritten once is restored to the original data afterwards, occurrence of unintended rewrite can be confirmed. For example, in the example above, after the control data corresponding to “92c747f65707143b” is written, when the control data is restored to the original data again, the second storage data 42 is arranged, for example, in the following order and stored.

“5ec8eee62e66457b”

“41f2d2da5d83ecf6”

“92c747f65707143b”

“41f2d2da5d83ecf6”

“7aa0371ff93d0144”

That is, because there are the hash codes, which originally do not exist, on the third and fourth lines, the update history can be reliably ascertained.

Further, in the present embodiment, because the hash codes are added to the storage data 41 and 42 in chronological order, the timing at which unintended rewrite has been performed can be confirmed. In the example above, it is easily confirmed that unintended rewrite has been performed after data update corresponding to “41f2d2da5d83ecf6” and before data update corresponding to “7aa0371ff93d0144”.

The present disclosure is not limited to the above embodiment, and can be widely applied.

For example, the data stored in the storage data 41 and 42 is not limited to the hash code, so long as the data can uniquely express characteristics of the control data and has a small volume of data.

The storage data 41 and 42 can have a configuration in which information specifying the vehicle is associated with the hash code or rewrite time of data is associated with the hash code. When the information specifying the vehicle is associated with the hash code, the data processing device 2 can reliably check a plurality of vehicle types and the update history of vehicles.

The present invention is not to be limited by the present embodiment including the modified examples with several kinds, locations and numbers of the structural elements aforementioned, and it is needless to say that such structural elements can be replaced with those having equivalent operations and effects within the gist of the present invention. The scope of the invention is defined with reference to the following claims.

We claim:

1. An electronic control unit of a vehicle comprising:
a storage unit that stores therein control data of a control target device, which is mounted on a vehicle, the control target device being controlled based on the control data stored in the storage unit;
a code generation unit that generates a unique code corresponding to control data after a change, when the control data stored in the storage unit is changed; and
a code recording unit that records the code.

2. The electronic control unit according to claim 1, wherein the code recording unit is configured to add a new code to the code already recorded and store therein the new code, when the code is newly generated.

3. The electronic control unit according to claim 1, wherein the code recording unit is configured to arrange and store therein the codes in order of the control data being updated.

4. A vehicle onboard electronic controller comprising:
a storage device storing control data used for controlling a control target device mounted on the vehicle;
an update unit receiving a new control data and updating the control data stored in the storage device by using the received new control data and outputting the thus updated control data;
a code generator receiving the updated control data and generating a unique code corresponding to the updated control data; and
a code recorder recording the unique code in a code storage.

5. The vehicle onboard electronic controller of claim 4, wherein the code recorder records the unique code in addition to an existing unique code already recorded in the code storage.

6. The vehicle onboard electronic controller of claim 5, wherein the code recorder records the unique code in chronological order.

7. The vehicle onboard electronic controller of claim 4, wherein the unique code is a unique hash code.

8. A method comprising steps performed by a vehicle onboard electronic controller:
storing, in a storage device mounted on a vehicle, control data used for controlling a control target device mounted on the vehicle;
updating the control data stored in the storage device by using a new control data received from outside of the vehicle;
generating a unique code corresponding to the thus updated control data; and
recording the unique code in a code storage mounted on the vehicle.
